(19) United States
(12) Patent Application Publication
(10) Pub. No.: US 2023/0071066 A1
(43) Pub. Date: Mar. 9, 2023

(54) OPTO-MECHANICAL PHASE SHIFTERS IN AN ACTIVE LIGHT DETECTION SYSTEM

(71) Applicant: Seagate Technology LLC, Fremont, CA (US)

(72) Inventor: Aditya Jain, Minneapolis, MN (US)

(21) Appl. No.: 17/898,071

(22) Filed: Aug. 29, 2022

Related U.S. Application Data
(60) Provisional application No. 63/241,788, filed on Sep. 8, 2021.

(51) Int. Cl. G01S 17/08; G01S 7/481; G02B 26/06; G02B 26/08

(52) U.S. Cl. CPC G01S 17/08; G01S 7/4814; G01S 7/4817; G02B 26/06; G02B 26/0825

(57) ABSTRACT

Method and apparatus for generating and controlling pulses in a light detection and ranging (LiDAR) system. An opto-mechanical phase shifter (OMPS) device has an array of unit cells supported by a semiconductor substrate. Each unit cell includes a resonator extending between opposing first and second doped regions and a flexible layer extending above the resonator separated by an intervening gap. Application of voltage across the doped regions establishes an electric field that extends through the resonator and controllably deforms the flexible layer to direct a beam of light in a desired direction and with a desired phase. A detector derives range information associated with a target illuminated by the directed beam of light. The derived range information can be used to adjust the voltage(s) applied to the OMPS device. Each unit cell can be independently activated and controlled, or groups of unit cells can be operated as a set.

### RELATED APPLICATIONS

The present application makes a claim of domestic priority under 35 U.S.C. 119(e) to U.S. Provisional Patent Application No. 63/241,788 filed Sep. 8, 2021, the contents of which are hereby incorporated by reference.

### SUMMARY

Various embodiments of the present disclosure are generally directed to a method and apparatus for directing light pulses in an active light detection and ranging (LiDAR) system.

Without limitation, some embodiments provide an opto-mechanical phase shifter (OMPS) device with an array of unit cells supported by a semiconductor substrate. Each unit cell includes a resonator extending between opposing first and second doped regions and a flexible layer extending above the resonator separated by an intervening gap. Application of voltage to the first and second doped regions establishes an electric field that extends through the resonator and controllably deforms the flexible layer to direct a beam of light in a desired direction and with a desired phase.

In further embodiments, a detector derives range information associated with a down range target illuminated by the directed beam of light from the OMPS device, and the derived range information can be used to adjust the voltage(s) applied to the OMPS device. Each unit cell can be individually and independently operated to scan a field of view (FoV).

These and other features and advantages of various embodiments can be understood from a review of the following detailed description in conjunction with a review of the accompanying drawings.

### BRIEF DESCRIPTION OF THE DRAWINGS

FIG. 1 is a block representation of a LiDAR system constructed and operated in accordance with various embodiments of the present disclosure.

FIG. 2 is a simplified functional representation of an emitter constructed and operated in accordance with some embodiments.

FIG. 3 depicts a generalized solid state phase array device that can be incorporated into an emitter such as in FIG. 2, the device characterized as an opto-mechanical phase shifter (OMPS) constructed and operated in accordance with various embodiments.

FIG. 4 is a simplified functional representation of a detector constructed and operated in accordance with some embodiments.

FIG. 5 depicts an OMPS device corresponding to the device in FIG. 3 in accordance with some embodiments.

FIG. 6 is a cross-sectional schematic depiction of a unit cell from the OMPS device of FIG. 5 in some embodiments.

FIG. 7 shows operation of portions of the unit cell of FIG. 6

FIG. 8 shows controlled operation another OMPS device in accordance with further embodiments.

FIG. 9 depicts a field of view (FoV) scanned by the OMPS of FIG. 8 in some embodiments.

FIG. 10 shows closed loop operation of yet another OMPS device in accordance with further embodiments.

FIG. 11 is a sequence diagram showing operation of the system of FIG. 1 in accordance with various embodiments.

FIG. 12 is a functional block representation of an adaptive OMPS control management system in accordance with further embodiments.

### DETAILED DESCRIPTION

Various embodiments of the present disclosure are generally directed to optimization of an active light detection system.

Light Detection and Ranging (LiDAR) systems are useful in a number of applications in which range information (e.g., distances, velocity, etc.) associated with a down range target is detected by irradiating the target with electromagnetic radiation in the form of light from an emitter. The range information is obtained by a detector in relation to timing characteristics of reflected light received back by the system.

LiDAR applications include topographical mapping, guidance, surveying, and so on. One increasingly popular application for LiDAR is in the area of autonomously piloted or driver assisted vehicle guidance systems (e.g., self driving cars, autonomous drones, etc.). While not limiting, the light wavelengths used in a typical LiDAR system may range from ultraviolet to near infrared (e.g., 250 nanometers, nm to 1500 nm or more). Other wavelength ranges can be used.

One commonly employed form of LiDAR is sometimes referred to as coherent pulsed LiDAR, which generally uses coherent light and detects the range based on detecting phase differences in the reflected light. Such systems may use a dual (I/Q) channel detector with an I (in-phase) channel and an orthogonal Q (quadrature) channel. Other forms of LiDAR systems can be used, however, including non-coherent light systems that may incorporate one or more detection channels.

Further alternatives that can be incorporated into LiDAR systems include systems that sweep the emitted light using mechanical based systems that utilize moveable mechanical elements, solid-state systems with no moving mechanical parts but instead use phase array mechanisms to sweep the emitted light in a direction toward the target, micro-mirror devices with individually controlled mirrored surfaces to scan the light beam, and so on.

Various embodiments of the present disclosure are directed to a method and apparatus for generating and directing light beams in a LiDAR system. As explained below, an opto-mechanical phase shifter (OMPS) device is provided to provide a solid-state array response in scanning light beams over a desired field of view (FoV). The OMPS device can be fabricated using otherwise conventional semiconductor integrated circuit (IC) fabrication style processes.

In some embodiments, the OMPS device has an array of resonators, or phase shifters, arrayed along a facing surface of the integrated circuit device (chip) as an array of unit cells. A flexible layer of material is arrayed across the resonators. An electrical field established by passage of electrical power (e.g., current/voltage) to doped regions causes deflection of the flexible layer and steering of an incident beam in a desired direction/phase.

A particular OMPS device may have many thousands or more of the unit cells, each independently and individually actuated to steer the incident light toward the FoV. The scanning can be performed along one or multiple orthogonal axes. In some embodiments, multiple OMPS devices can be combined to direct the light from one or more light sources.

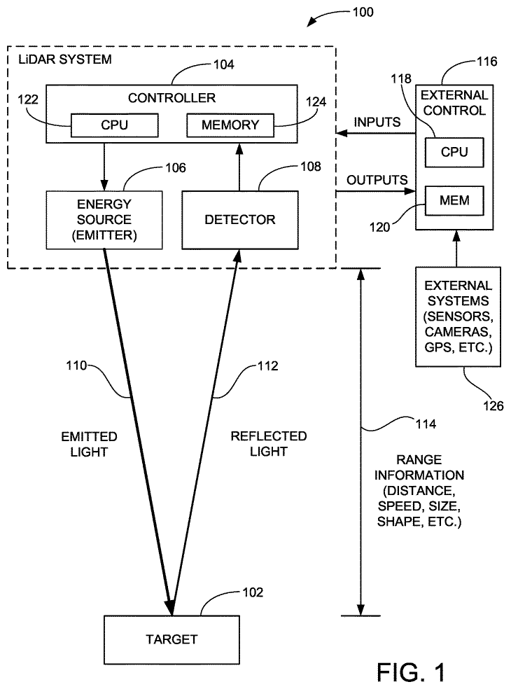

These and other features and advantages of various embodiments can be understood beginning with a review of FIG. 1 which provides a generalized representation of a LiDAR system 100. The LiDAR system 100 is configured to obtain range information regarding a target 102 that is a physical element located distal (down range) from the system 100. The range information can be beneficial for a number of areas and applications including but not limited to topography, archeology, geology, surveying, geography, forestry, seismology, atmospheric physics, laser guidance, automated driving and guidance systems, closed-loop control systems, etc.

The LiDAR system 100 includes a controller 104 which provides top level control of the system. The controller 104 can take any number of desired configurations, including hardware and/or software. In some cases, the controller can include the use of one or more programmable processors with associated programming (e.g., software, firmware) stored in a local memory which provides instructions that are executed by the programmable processor(s) during operation. Other forms of controllers can be used, including hardware based controllers, digital signal processors (DSPs), field programmable gate arrays (FPGAs), system on chip (SOC) integrated circuits, application specific integrated circuits (ASICs), gate logic, reduced instruction set computers (RISCs), etc.

An energy source circuit 106, also sometimes referred to as an emitter or a transmitter, operates to direct electromagnetic radiation in the form of light pulses toward the target 102. A detector circuit 108, also sometimes referred to as a receiver or a sensor, senses reflected light pulses received back from the target 102. The controller 104 directs operation of the emitted light from the emitter 106, denoted by arrow 110, and decodes information from the reflected light obtained back from the target, as denoted by arrow 112.

Arrow 114 depicts the actual, true range information associated with the intervening distance (or other range parameter) between the LiDAR system 100 and the target 102. Depending on the configuration of the system, the range information can include the relative or absolute speed, velocity, acceleration, distance, size, location, reflectivity, color, surface features and/or other characteristics of the target 102 with respect to the system 100.

The decoded range information can be used to carry out any number of useful operations, such as controlling a motion, input or response of an autonomous vehicle or object, generating a topographical map, recording data into a data structure for further analysis and/or operations, etc. The controller 104 perform these operations directly, or can communicate the range information to an external control system 116 for further processing and/or use.

In some cases, inputs supplied by the external control system 116 can activate and configure the system to capture particular range information, which is then returned to the system 116 by the controller 104. The external system can take any number of suitable forms, and may include a system controller (such as CPU 118), local memory 120, etc. The external system may form a portion of a closed-loop control system and the range information output by the LiDAR system 100 can be used by the external system 116 to adjust the position of a moveable element.

As noted above, the controller 104 can take a number of forms. In some embodiments, the controller 104 incorporates one or more programmable processors (CPU) 122 that execute program instructions in the form of software/firmware stored in a local memory 124, and which communicate with the external controller 118.

An additional number of systems 126 can provide information to the external control system 116 and/or the LiDAR system 100. The external systems can take any number of forms including but not limited to environmental sensors (e.g., temperature sensors, moisture sensors, timers, ambient light level sensors, ice detectors, etc.), cameras, geopositioning systems (e.g., global positioning systems, GPS), radar systems, proximity sensors, speedometers, etc.

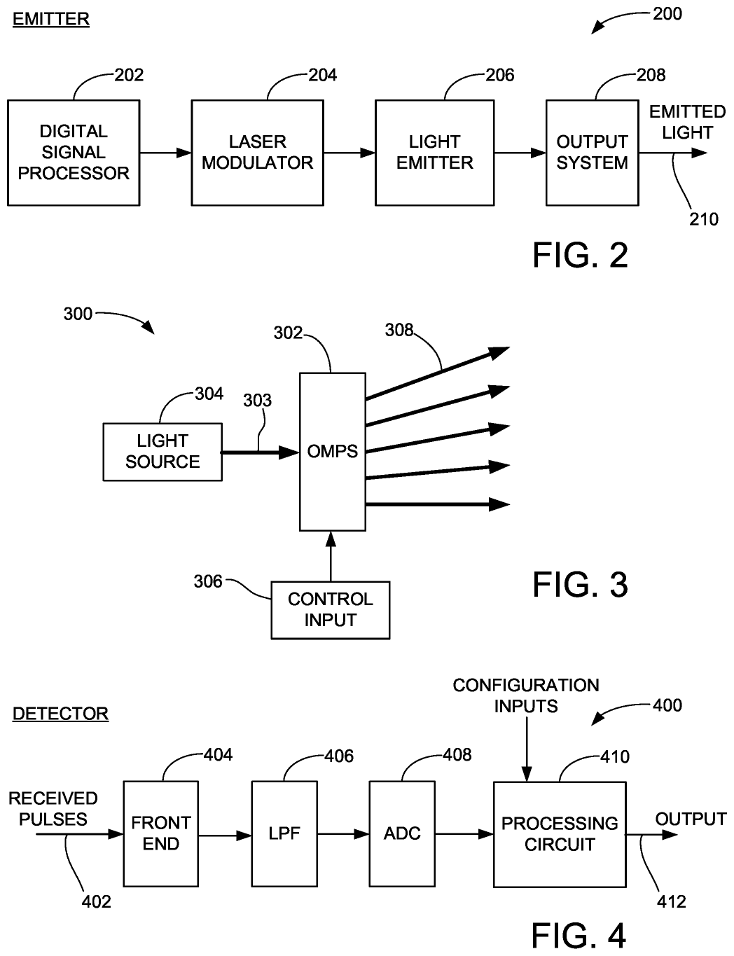

FIG. 2 depicts an emitter circuit 200 incorporated into the system 100 of FIG. 1 in some embodiments. Other arrangements can be used so the configuration of FIG. 2 is merely illustrative and is not limiting. The emitter circuit 200 includes a digital signal processor (DSP) that provides adjusted inputs to a laser modulator 204, which in turn adjusts a light emitter (e.g., a laser, a laser diode, etc.) that emits electromagnetic radiation (e.g. light) in a desired spectrum. The emitted light is processed by an output system 208 to issue a beam of emitted light 210. The light may be in the form of pulses, coherent light, non-coherent light, swept phase modulated continuous wave (PMCW) light, frequency modulated continuous wave (FMCW) light, etc.

FIG. 3 is a functional block representation of an output system 300 incorporated into the system of FIG. 2 as the output system 208 in some embodiments. The system 300 includes an opto-mechanical phase shifter (OMPS) device 302 configured and operated as explained in detail below. The OMPS device 302 receives input light beams 303 from a light source 304 such as a laser diode, etc., and in response to various input signals from a control input block 306, redirects (steers) light beams/pulses 308 in various desired directions and at various phases. The actual positions, directions and angles of the incident and directed light will depend on the configuration of the system, so that FIG. 3 is merely illustrative in nature.

FIG. 4 provides a generalized representation of a detector circuit 400 configured to process reflected light issued by the system of FIG. 2 and the OMPS device 302 of FIG. 3. Other configurations can be used. The detector circuit 400 receives reflected pulses 402 from targets in the down range FoV. The reflected pulses 402 are processed by a suitable front end 404. The front end 404 can include optics, detector grids, amplifiers, mixers, and other suitable features to present input pulses reflected from the target.

A low pass filter (LPF) 406 and an analog to digital converter (ADC) 408 can be used as desired to provide processing of the input pulses. A processing circuit 410 provides suitable digital signal processing operations to generate a useful output 412. The detector 400 is configured to operate using input signals from the emitter 200.

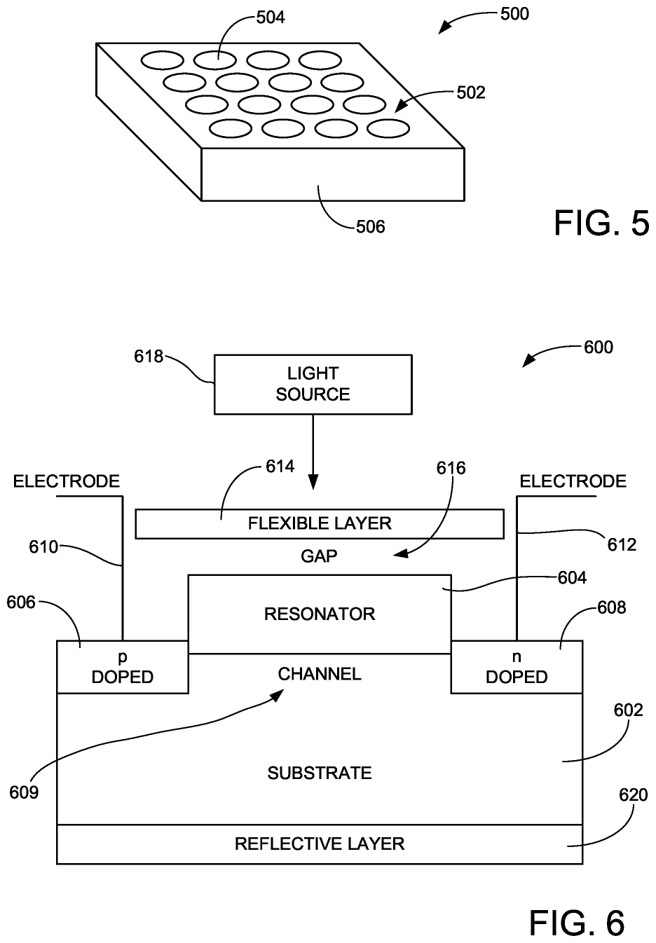

FIG. 5 shows an optics assembly 500 constructed and operated in accordance with various embodiments. The assembly 500 includes an OMPS device 502 that corresponds to the output system 208 in FIG. 2 and the OMPS device in FIG. 3. Other arrangements can be used.

The OMPS 502 is a solid state integrated circuit (IC) device (chip) that includes an array of unit cells 504 spaced across and supported by a corresponding semiconductor substrate 506. The size and spacing of the unit cells 504 will tend to be less than the wavelength of the light projected from a source (e.g., 206, 304). It is contemplated that each of the unit cells is individually and independently tunable and operable, although groups of unit cells can receive the same nominal control inputs and be controlled as a set. Many hundreds or thousands of the cells 504 (or more) may be provided as required in each substrate 506, although other numbers and arrangements of cells can be utilized. Some embodiments contemplate an array of multiple OMPS devices that direct light from one or multiple sources along a single or multiple axes.

FIG. 6 is a simplified schematic depiction of a selected unit cell 600 corresponding to the unit cells 504 in FIG. 5. The cell 600 incorporates a semiconductor substrate 602, which may be any suitable material such as silicon based semiconductor material including but not limited to dioxide (SiO2), silicon nitride (Si3N4), etc. A resonator 604 extends above and projects from the semiconductor substrate 602. While not necessarily required, it is contemplated that the resonator will formed of a dielectric silicon based material such as those materials described above and may be cylindrically shaped as shown.

A pair of doped regions 606, 608 are provided on opposing sides of the channel 602 and resonator 604. Region 606 may be p-doped and region 608 may be n-doped, although other configurations can be used. A channel 609 of the substrate 602 extends between the doped regions 606, 608 and below the resonator 604. Electrically conductive electrodes 610, 612, arranged as electrically conductive paths, interconnect the respective doped regions 606, 608.

A flexible dielectric layer 614 extends above the resonator 604 and is separated therefrom by an interior gap 616. The gap 616 can be characterized as a fluidic gap or an air gap in some embodiments. A suitable gas can be introduced in the gap 616 including air, an inert gas (e.g., helium, argon, nitrogen, etc.), a low pressure vacuum, a full vacuum, etc. Regardless, it will be understood that the gap 616 represents a physical gap between the resonator 604 and the layer 614 so these are in noncontacting relation at least in some operational modes and the layer 614 is able to be physically displaced with respect to the resonator 604.

Both the resonator 604 and layer 614 are contemplated as being formed of dielectric materials and are nominally optically translucent over the wavelengths of interest. One suitable material for the layer 614 is silicon nitride (Si3N4), although other materials can be used. The layer 614 may extend across the entirety of the facing surface of the underlying structure (e.g., at least channel 609 and resonator 616).

The layer 614 can be arranged so as to sealingly cover and encapsulate the cell 600, so that the gap 616 is sealed with respect to the surrounding environment. In an alternative embodiment, the gap 616 in each cell 700 is fluidically coupled to the surrounding external atmosphere, so that the gap 616 in each cell is an air gap at the same pressure and atmospheric constitution as the surrounding atmospheric environment.

In further embodiments, a single layer of material corresponding to the layer 614 can be applied to encapsulate all of the unit cells 600 on the underlying substrate 602 (or 506, FIG. 5). In yet other embodiments, individual discrete layers 614 are used to cover each unit cell 600 in turn.

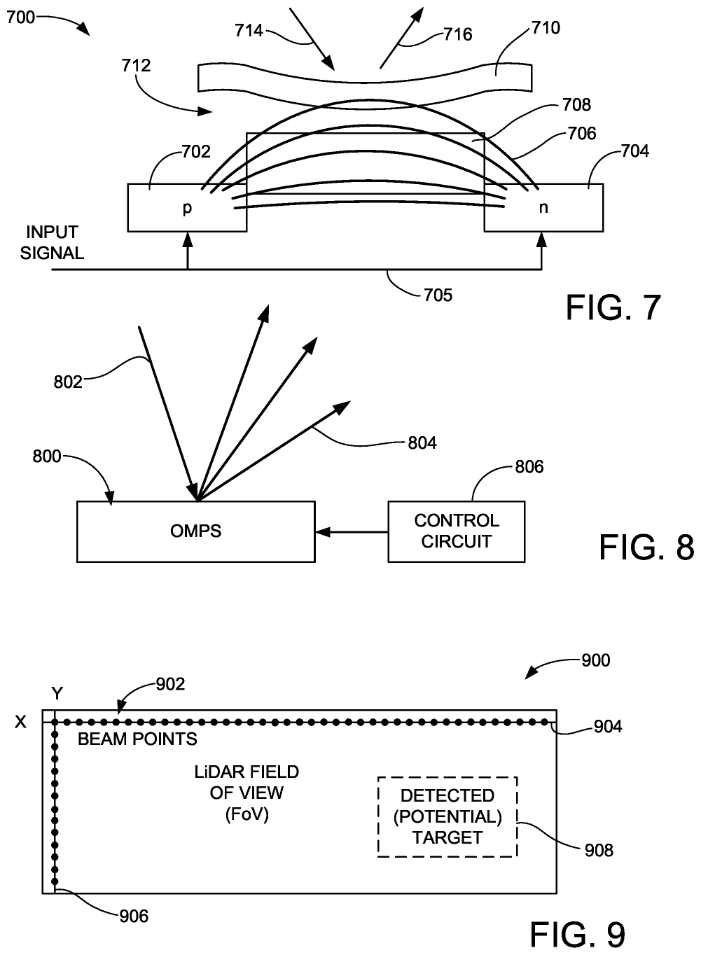

Further features in FIG. 6 include a light source 618 and a reflective metal layer 620. In this way, light can be introduced downwardly, resonate within the resonator and/or pass down to the reflective layer and back up. Controlled deflection of the flexible layer 614 provides the desired phase shifting characteristics of the emitted light, as will now be discussed in FIG. 7.

FIG. 7 shows control aspects of the unit cells 504, 600 described above for a particular unit cell 700. Application of voltage across p and n regions 702, 704 via input signal on path 705 establishes an electrical field 706 that extends through resonator 708 and flexible layer 710. The field 706 tends to attract, repel or otherwise deform the flexible layer 710, changing the relative distance between the resonator 708 and layer 710 which are separated by fluid within intervening gap 712.

An input beam of light is denoted at 714, and a corresponding output beam of light is denoted at 716. The output beam of light 716 is directed (steered) along one or multiple axes in response to the application of the input control signal applied to the regions 702, 704 via signal path 705 and the resulting mechanical deformation of the layer 710. It will be appreciated that the layer 710 can be deflected towards the resonator 708 or away from the resonator 708 as required depending on the field generated by the regions 702, 704, allowing a wide range of deflection angles for the incident light beams applied thereto.

This operation is illustrated by FIG. 8 which shows a related OMPS device 800 in which incident light 802 from a light source (e.g., 206, 304, 618) can be controllably directed to provide emitted light 804 over a suitable range responsive to control inputs supplied to the OMPS device 800 by a control circuit 806.

It is contemplated that the OMPS devices disclosed herein can be fabricated using otherwise conventional semiconductor materials and processes. The disclosed OMPS device can be viewed as a hybrid device with both mechanical and solid state electrical characteristics, hence the use of the descriptor “opto-mechanical phase shifter”.

FIG. 9 shows a field of view (FoV) 900 scanned by an OMPS such as the device 800 in FIG. 8. The FoV 900 is scanned via beam points 902 that are arranged along multiple orthogonal x and y axes 904, 906. It will be appreciated that in alternative embodiments, other scanning patterns can be provided including along a single axis, along a non-Cartesian axis system, etc. In some cases, multiple OMPS devices are provided to provide scanning in each axis (e.g., a first OMPS device to scan in the horizontal x-axis direction and a second OMPS device to scan in the vertical y-axis direction).

A potential detected target is represented at 908. Reflected beams from the target are processed by a detector (such as n FIG. 4) to obtain range information therefor. In some cases, normal scanning (rasterizing) patterns can be applied across the FoV 900, and upon the detection of a potential target of interest, additional scans can be locally supplied to the region associated with the detected target (including scans with greater numbers of beam points, different scan directions, etc.).

Depending on the configuration of the system, several thousands, hundreds of thousands, or even millions of beam points may be transmitted over the FoV 900 each second. The beam points may be arranged as a succession of frames (e.g., each rasterized scan of the FoV), with many frames being scanned each second. The particular beam densities and decoding strategies will depend on the requirements of a given operation. It will be appreciated that the solid-state nature of the OMPS devices described herein provide precise and efficient direction of beam points to any given location as desired, including localized repeating patterns with higher densities and/or refresh rates to cover precise target areas.

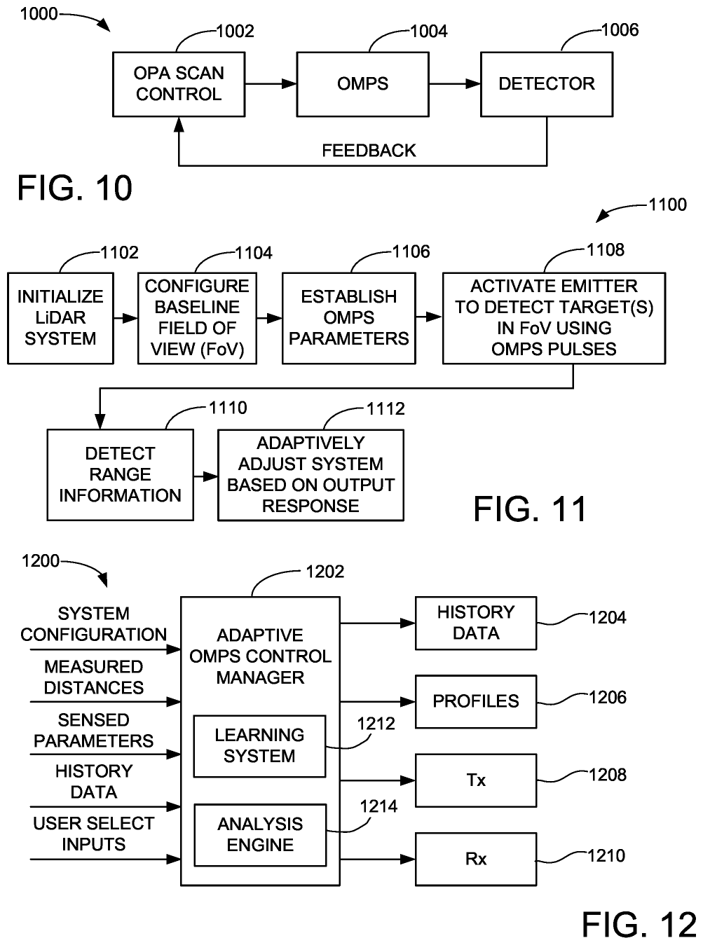

Closed loop operational control of the OMPS devices is contemplated. FIG. 10 shows a control system 1000 constructed and operated in accordance with some embodiments in which an OMPS scan controller circuit 1002 directs an OMPS device 1004 to direct beams down range as described above. A detector 1006 such as in FIGS. 1 and 4 detects potential targets from the reflected light beams, and provides associated feedback information back to the OMPS scan controller 1002 to adjust the operation of the OMPS device 1004.

FIG. 11 provides a sequence diagram 1100 to illustrate operations that can be carried out in accordance with the foregoing discussion. Other operational steps can be carried out as required, so that FIG. 11 is merely exemplary and is not limiting.

A LiDAR system such as described above is initialized at block 1102. As part of the transitioning of the system to an operationally ready mode, a baseline FoV (such as in FIG. 9) is selected at block 1104 and various OMPS parameters are implemented at block 1106.

Thereafter, normal operation commences at block 1106 in which an emitter (such as in FIG. 2) is activated to emit light beams toward the associated FoV using one or more OMPS devices to rasterize the scan pattern. Such operation may result in the detection of one or more potential targets within the FoV based on reflected light therefrom. As shown by block 1110, the reflected light beams are processed by a detector (such as in FIGS. 4 and 10) to decode range information associated with such targets. As desired, the system can be adaptively adjusted based on the output range information at block 1112, such as in the manner described above in FIG. 10.

FIG. 12 provides a functional block representation of an adaptive OMPS control system 1200. The system can be incorporated into the LiDAR system 100 in FIG. 1, including as aspects of the emitter, detector and/or controller. The system 1200 includes an adaptive OMPS control manager circuit 1202, which in some embodiments may be realized as one or more programmable processors that execute program instructions (e.g., software, firmware) stored in a local memory.

The circuit 1202 operates to control the operation of the one or more OMPS devices in the system to controllably scan the selected FoV (or selected portions thereof). The circuit 1202 may operate responsive to various inputs, such as but not limited to system configuration operation, measured distances or other decoded range information, sensed parameters (including operational parameters and/or environmental parameters), history data associated with previous scans, and user selected inputs to select different modes of operation for different operational conditions.

In response, the manager circuit 1202 provides a number of outputs such as the accumulation of history data 1204 in a suitable local memory, the generation and utilization of various operational profiles 1206 that provide different control voltages or other parameters to operate the OMPS as described above. Outputs are further supplied as required to a transmitter, Tx 1208 (corresponding to the emitters described above) and/or a receiver, Rx 1210 (corresponding to the detectors described above).

In further embodiments, the manager circuit 1202 can incorporate additional capabilities such as a machine learning system 1212 that utilizes artificial intelligence, neural networks and/or other techniques to accumulate and implement operational parameters to enhance operation of the system. An analysis engine 1214 can be used to perform complex calculations, predictions or other operations suitable to enhance operation of the system.

While coherent, I/Q based systems have been contemplated as a basic environment in which various embodiments can be practiced, such are not necessarily required. Substantially any type of LiDAR system can be configured to utilize the various OMPS devices disclosed herein, including but not limited to coherent, incoherent, phase modulated continuous wave (PMCW), frequency modulated continuous wave (FMCW), etc.

It is to be understood that even though numerous characteristics and advantages of various embodiments of the present disclosure have been set forth in the foregoing description, together with details of the structure and function of various embodiments of the disclosure, this detailed description is illustrative only, and changes may be made in detail, especially in matters of structure and arrangements of parts within the principles of the present disclosure to the full extent indicated by the broad general meaning of the terms in which the appended claims are expressed.

What is claimed is:

1. An opto-mechanical phase shifter (OMPS) device comprising an array of unit cells supported by a semiconductor substrate, each unit cell comprising a resonator extending between opposing first and second doped regions of the substrate semiconductor and a flexible layer extending adjacent the resonator and separated therefrom by an intervening gap, wherein application of voltage to the first and second doped regions establishes an electric field that extends through the resonator and controllably deforms the flexible layer to direct a beam of light in a desired direction and with a desired phase.

2. The OMPS device of claim 1, wherein the flexible layer and the resonator are formed of a translucent dielectric material to facilitate passage of the beam of light into the semiconductor substrate at a first angle and out of the semiconductor substrate at a selected second angle.

3. The OMPS device of claim 2, further comprising a metallic reflective layer affixed to the semiconductor substrate opposite the resonator to reflect the beam of light at the selected second angle.

4. The OMPS device of claim 1, wherein the substrate is formed of semiconductor material to form a channel between the respective first and second doped regions, wherein the resonator is disposed over and in contacting relation with the channel, and wherein corresponding first and second electrically conductive electrodes are affixed to the respective first and second doped regions.

5. The OMPS device of claim 1, wherein the intervening gap is sealed to retain a volume of a selected fluid between the resonator and the flexible layer.

6. The OMPS device of claim 5, wherein the selected fluid comprises an inert gas.

7. The OMPS device of claim 1, in combination with a light source to direct incident light onto the unit cells for direction across a field of view (FoV) of a light detection and ranging (LiDAR) system, the incident light being provided at a first angle with respect to a selected unit cell of the OMPS device and the incident light being redirected at a different second angle with respect to the selected unit cell of the OMPS device responsive to a magnitude of the voltage applied to the first and second doped regions of the selected unit cell.

8. The OMPS device of claim 6, further in combination with a detector configured to detect range information associated with a target illuminated by the beam of light directed by the OMPS device, and further in combination with a controller circuit which adjusts a voltage applied to the electrodes of at least one unit cell of the OMPS device responsive to the range information detected by the detector.

9. A light detection and ranging (LiDAR) system comprising:
a light source configured to generate electromagnetic radiation in the form of a beam of light;
an opto-mechanical phase shifter (OMPS) device configured to direct the beam of light from the light source across a selected field of view (FoV), the OMPS device comprising a semiconductor substrate and an array of unit cells supported by the semiconductor substrate, each of the unit cells comprising opposing first and second doped regions to form a channel therebetween, a resonator block of dielectric material adjacent the channel, and a flexible layer extending in noncontacting spaced apart relation to the resonator block to form a gap therebetween; and
a control circuit configured to apply a voltage across the first and second doped regions of at least one of the unit cells to establish an electrical field that controllably deforms the associated flexible layer to direct the beam of light in a desired direction toward the FoV.

10. The LiDAR system of claim 9, further comprising a detector circuit configured to detect range information associated with a target illuminated by the beam of light directed by the OMPS device.

11. The LiDAR system of claim 10, wherein the control circuit adjusts the voltage applied to the at least one of the unit cells responsive to the range information detected by the detector.

12. The LiDAR system of claim 9, wherein the OMPS device scans the FoV along at least two orthogonal axes.

13. The LiDAR system of claim 9, wherein the flexible layer and the resonator of each unit cell are each formed of a translucent dielectric material to facilitate passage of the beam of light into the semiconductor substrate at a first angle and out of the semiconductor substrate at a selected second angle.

14. The LiDAR system of claim 13, wherein each of the unit cells further comprises a metallic reflective layer affixed to the semiconductor substrate opposite the associated resonator to reflect the beam of light at the selected second angle.

15. The LiDAR system of claim 9, wherein the semiconductor substrate is formed of silicon, a selected one of the first and second doped regions is a p-doped region, and a remaining one of the first and second doped regions is an n-doped region.

16. The LiDAR system of claim 9, wherein the light source is a laser diode that outputs light with a wavelength of from about 250 nanometers, nm to about 1550 nm.

17. The LiDAR system of claim 9, wherein each of the unit cells provides a sealed volume of gas within the gap between the flexible layer and the resonator.

18. A method, comprising:
generating electromagnetic radiation in the form of a beam of light from a light source;
impinging the beam of light onto an opto-mechanical phase shifter (OMPS) device at a first angle, the OMPS device comprising a semiconductor substrate and an array of unit cells supported by the semiconductor substrate, each of the unit cells comprising opposing first and second doped regions to form a channel therebetween, a resonator block of dielectric material adjacent the channel, and a flexible layer extending in noncontacting spaced apart relation to the resonator block to form a gap therebetween; and
applying a voltage across the first and second doped regions of at least one of the unit cells to establish an electrical field that controllably deforms the associated flexible layer to direct the beam of light from the OMPS at a different, second angle toward a field of view (FoV).

19. The method of claim 18, further comprising detecting a target within the FoV responsive to reflected light received at a detector and using the reflected light to derive range information associated with the target.

20. The method of claim 19, further comprising adjusting the voltage applied across the first and second doped regions to the at least one of the unit cells responsive to the derived range information from the detector.
